(19) United States
(12) Patent Application Publication
(10) Pub. No.: US 2004/0189803 A1
(43) Pub. Date: Sep. 30, 2004

(54) Complete automobile recording (C.A.R.) seat

(76) Inventor: Phillip Wayne Price, Canton, GA (US)

Correspondence Address: Phillip Wayne Price, Building 132, 2920 Marietta Highway, Canton, GA, 30114, US

(21) Appl. No.: 10/402,769

(22) Filed: Mar. 29, 2003

(51) Int. Cl. H04N 7/18

(52) U.S. Cl. 348/151; 348/143

(57) ABSTRACT

A light weight, portable, concealable platform which provides for recording of audio and video from a camera and microphone located inside the platform. The platform is a standard child's heavy duty car safety seat, with the above described items, a video camera with zoom, a microphone and an outlet for recording by way of an electronic connection, a video cassette recorder, and a monitor to verify the picture recorded and to aim and focus the camera.

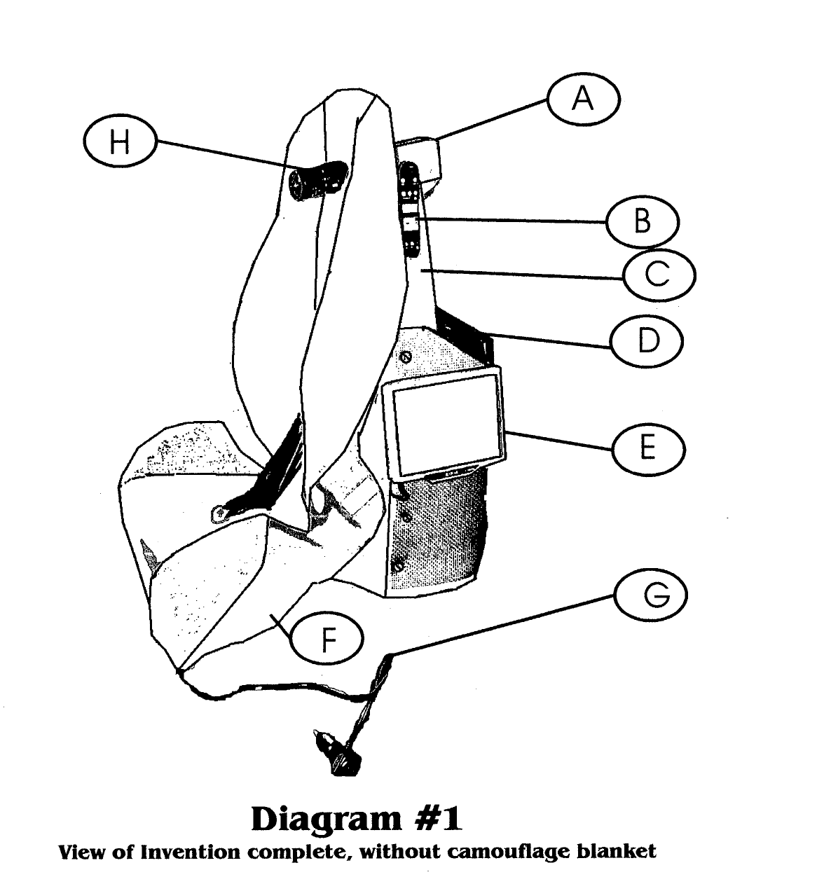

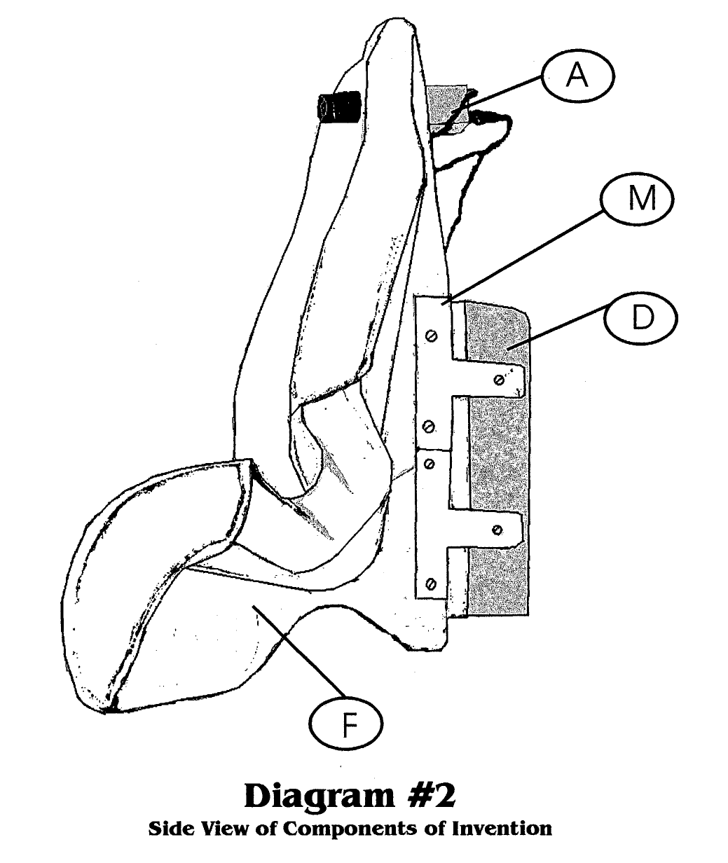

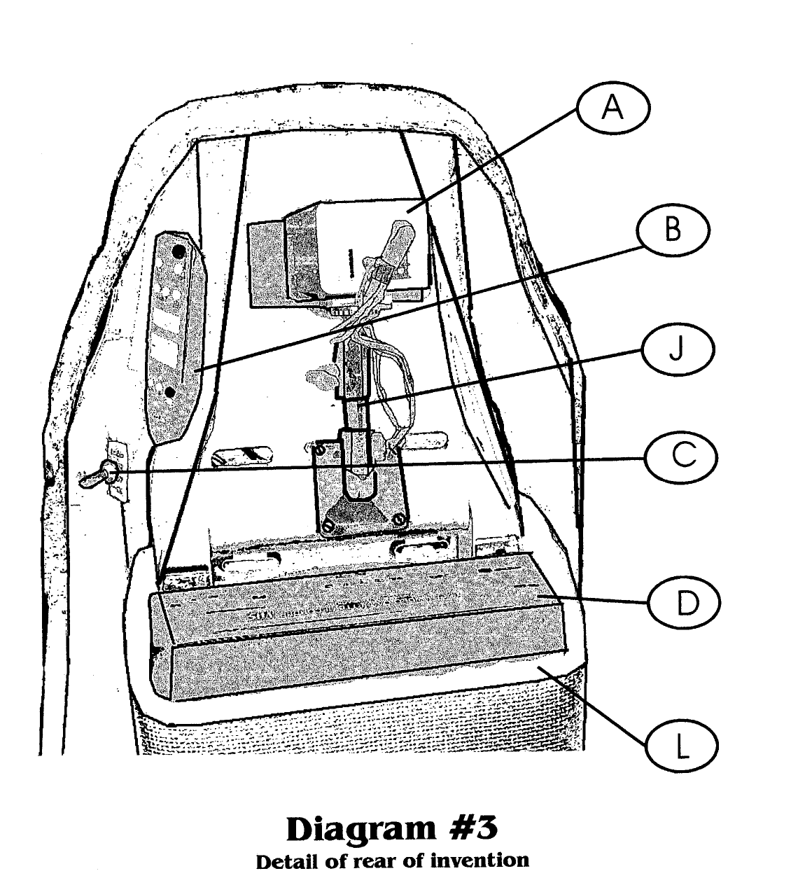

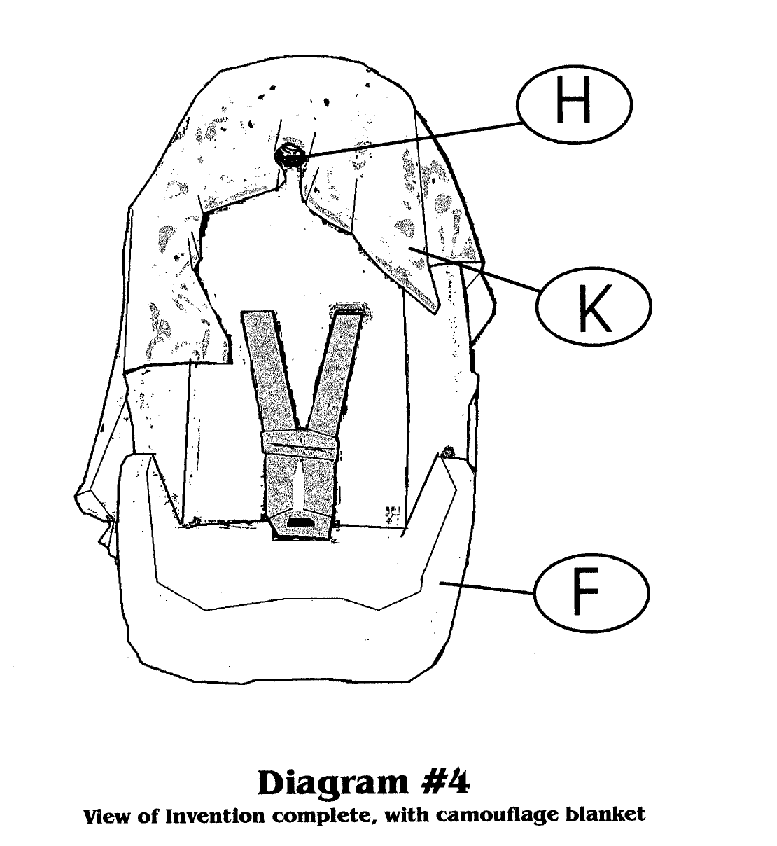

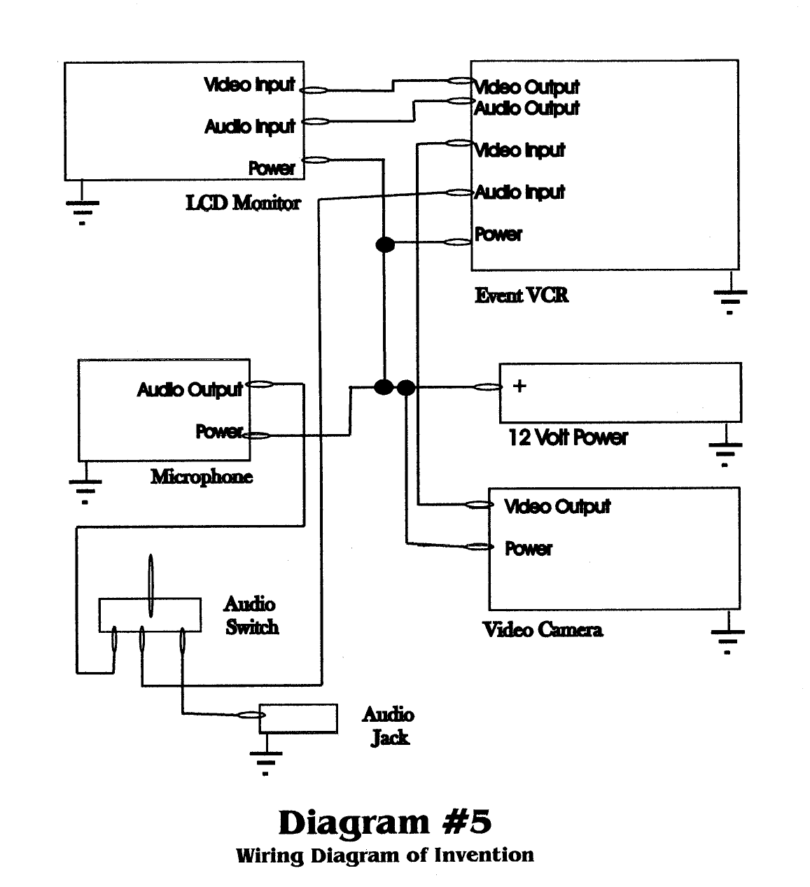

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to surveillance equipment, specifically to such equipment which is portable, concealable, offers ease of operation, can be quickly changed from location to location and has the ability to record visual and audio images during law enforcement and private security surveillance activities.

2. Background of the Invention

Undercover police personnel and private investigators often use video and audio equipment while operating a surveillance of a specific transaction or a surveillance of a subject or groups of subjects. Surveillance equipment is needed in undercover drug investigations, undercover surveillance of suspicious persons or vehicles in order to record the transaction or actions, and for the development of evidence for use in adjudication of criminal cases. Surveillance equipment is needed by private investigators to record the movements of certain subjects in illicit or immoral activities, or in instances of fraud or other malfeasance. Surveillance equipment is used in insurance fraud prosecution to record activities of certain individuals who may claim to be injured.

a) Said equipment is often hand held by personnel, which requires that the operator be with the equipment at all times, and that it be monitored by specific personnel at all times.

b) Investigators using surveillance equipment are often visible, due to the size of normal surveillance cameras which are commercially available, therefore arousing suspicion on the part of the subject.

c) Personnel may need to leave equipment unmanned for periods of time therefore, missing important parts of a surveillance.

d) Said equipment is difficult to keep steady over periods of time therefore distorting the quality of the recording.

e) Said equipment has no control over the type of audio signal introduced to the recording, and may pick up other noises that are not part of the surveillance operation, and therefore making an audio recording difficult or impossible to understand.

f) If not handheld, surveillance equipment is often large and cumbersome.

g) Such equipment may be custom-made into an expensive, purpose built vehicle, therefore making it expensive, difficult to move (as in the case of a pursuit), and requiring that it be parked at a considerable distance to avoid detection on frequent operations in the same area.

h) Equipment may be dangerous or impossible for an operator to operate while moving.

i) Body-bugs worn by undercover agents have no recording capacity, therefore providing only part of the surveillance.

j) Surveillance equipment has historically had to be fairly close to be able to achieve a clear picture of the subject or transaction to be used in prosecution later.

k) Traditional equipment tends to arouse suspicion from a subject who does not want to be watched or recorded and is savvy about recognizing surveillance equipment.

### BACKGROUND OF THE INVENTION—OBJECTS AND ADVANTAGES

The inventor has spent 25 years practicing surveillance techniques. The inventor is aware of the complexity of most purpose built surveillance equipment, and the high cost associated with these specialized vehicles. The inventor identified the requirements of public and private surveillance operators and has created a mobile, compact, unobtrusive surveillance platform which can be built for a fraction of the cost of purpose built vehicles.

Several objects and advantages of the CAR Sear are:

a) To provide a mobile surveillance platform which can be used in various vehicles without modification.

b) To provide a portable surveillance platform, easily carried by the average healthy man or woman.

c) To provide high quality visual recording of subjects or transactions either at close range or some distance away.

d) To provide high quality audio recordings of subjects or transactions at the same time as providing visual recordings, again either at close range or some distance away.

e) To provide selectable audio sources which may be chosen by the operator to facilitate the use of the best source of audio signal.

f) To provide a platform for making such recordings which would not arouse suspicion on the part of the subject or the public.

g) To provide a platform for making such recordings which does not necessarily have to be manned for hours at a time.

h) To provide a platform for making these recordings which could be operated while moving without jeopardizing the operator's safety.

i) To provide a platform for making said recordings under various lighting conditions.

### SUMMARY

In accordance with the current invention, the CAR Seat comprises a surveillance platform built into a child's car safety seat which has the capacity to record visual and audio images from some distance. The CAR Seat may be monitored by the driver of the vehicle, but does not have to be. The CAR Seat is mobile and portable and less costly than conventional surveillance equipment. The CAR Seat is camouflaged in such a way that it does not arouse suspicion on the part of the subject or the public. The CAR Seat utilizes standard VHS tapes, a simple to use video camera, and is plugged into the vehicle cigarette lighter for a source of power.

### DRAWINGS—FIGURES

The surveillance equipment is built into a standard forty-pound plus size child's safety car seat (FIG. F in Diagram 1, Diagram 2, and Diagram 4).

A hole is cut into the upright back of the child's safety seat.

A low light capable color video camera (FIG. A in Diagram 1, 2, 3 and 4) with a manually operated zoom and focus function lens (FIG. H in Diagram 1 and Diagram 4) is used for the installation

The camera is mounted atop a multi-position bracket (FIG. J in Diagram 3) which is bolted onto the plastic car seat.

A video cassette recorder (VCR) (FIG. D in Diagram 1, Diagram 2, and Diagram 3) is bolted onto the rear of the car seat with two T brackets (FIG. M in Diagram 2) on each side. The VCR is then wrapped with a neoprene cover which acts as a shock absorbing surface (FIG. L in Diagram 3). The VCR remote control (FIG. B in Diagram 1 and Diagram 3) is mounted using Velcro fasteners to the side of the car seat.

A 5″ TFT LCD monitor (FIG. E in Diagram 1) is bolted onto the left lower side of the car seat.

A switch (FIG. C in Diagram 1 and Diagram 3) is positioned on the left side of the car seat and accessible to the operator. A high gain microphone with mini preamplifier is flush mounted on the left hand side of the child safety seat above the switch.

Wiring for power and signals from the four pieces of equipment are run between the cloth covering and the hard plastic back of the car seat, so as to conceal and protect it. All wiring is to be routed out of the underside of the seat (the specific routing of the various cables is depicted in Diagram 5).

The system is powered by a cord which terminates in a universal 12 volt automobile plug with an on-off switch (FIG. G in diagram 1).

The entire top of the seat is draped with a common cloth blanket (FIG. K in Diagram 4) prior to use to disguise the camera lens (FIG. H in Diagram 4) protruding from the seat.

### DETAILED DESCRIPTION AND OPERATION

The CAR Seat is made from an upright child's forward facing safety seat. Construction of the device will make maximum use of the existing properties of the safety seat in order to conceal the actual purpose of the device. The inventor removes the cloth covering of the car seat. A hole is cut into the upright back of the child's safety seat 6 inches from the top, equal distance from each side. The hole is cut to leave a 6 by 6 inch square.

A low light capable color video camera (FIG. A in Diagram 1, 2, and 3) with a manually operated zoom and focus function lens (FIG. H in Diagram 1, and Diagram 4) is used for the installation. The camera is a 12 volt type which operates in both ambient lighting, and with the use of ultraviolet light. Any 12 volt powered camera may be fitted in the bracket and through the opening, but the preferred camera would have a manual zoom capability, a low light capability, and be relatively small in size. The camera accepts an auto iris lens, and should operate at visibilities of 0.08 lux. The video output is by way of a BNC connector on the rear of the camera. The camera is equipped with a vari-focal, DC type lens with four-pin cable and a focal view of between 8.5 and 51 mm.

The camera is mounted atop a multi-position bracket (FIG. J in Diagram 3) which is bolted onto the plastic car seat using 8 mm screws. The camera is mounted in such a way that the lens is pointed through the above described six inch square hole. Once the covering is replaced on the seat a hole is cut into the cloth covering, allowing only the camera lens to protrude from the back of the car seat.

Next, a 12 volt, event type, video cassette recorder (VCR) (FIG. D in Diagram 1, Diagram 2, and Diagram 3) is bolted onto the rear of the car seat with two T brackets (FIG. M in Diagram 2) on each side, and held in place with the use of 10 8 mm screws on each side. The VCR is bolted 3 and one half inches from the top ledge of the car seat and equal distances from each side. A one half inch rubber cushion material is wrapped around the outside beginning just below or behind the controls for the VCR. Therefore, there are no loose pieces, or sharp edges, and the matting is also sound and shock absorbent. The VCR is then wrapped from the left side across the top (outside) to the right side with a neoprene cover which acts as a shock absorbing surface (FIG. L in Diagram 3). The cover is secured with 10 8 mm screws.

The VCR remote control (FIG. B in Diagram 1 and Diagram 3) is mounted above the switch and the microphone using Velcro fasteners to the side of the car seat.

A 5″ TFT LCD monitor (FIG. E in Diagram 1) is bolted onto the left lower side of the car seat with a rotator cuff bolt bracket assembly and 4 8 mm screws. The monitor is bolted at the lower edge of the car seat, 10 inches from the bottom of the safety seat.

A switch (FIG. C in Diagram 3) is positioned on the left side of the car seat and accessible to the operator. The switch is a double-pole, double throw center off. The center position on the switch provides direct access to the audio input jack on the VCR. One pole of the switch is connected to a line-level type microphone which is mounted into the left side of the car seat near the switch. The other pole is connected to an RCA type jack mounted on the left side of the car seat near the switch. This jack will allow for recording of radio signals and other input devices to the VCR.

A high gain microphone with mini preamplifier is placed on the left hand side of the child safety seat with the microphone flush mounted near the top of the seat adjacent to the camera.

Wiring for power and signals from the four pieces of equipment are run between the cloth covering and the hard plastic back of the car seat, so as to conceal and protect it. All wiring is to be routed out of the underside of the seat. The specific routing of the various cables is depicted in Diagram 5.

Each item is powered by 12 volts and is connected back to a common positive and negative point underneath the car seat. The wires are attached with solder-less connectors and attached to a 12 volt switched plug appropriate to plug into the vehicle cigarette lighter.

The video output of the camera is routed to the video input of the VCR by way of a BNC to RCA type 3 foot cable. The output of the microphone is routed to the audio input of the VCR through the switch described above. The microphone terminates in an RCA type male connection. A 3 foot cable with a female RCA connection is routed to the switch and is connected to one pole of the switch. A second cable, one foot in length with a female RCA type connection is routed through a hole near the switch and is then connected to the other pole of the switch. A 3 foot cable with an RCA male connector is connected to the common pole of the switch and is routed to the audio input connector on the VCR. The video and audio output jacks are connected via cables with RCA male connectors on each end routed to the video and audio connections on the monitor.

A baby blanket (FIG. K in Diagram 4) is attached with Velcro type fasteners to the top of the back of the device near the controls of the VCR, and on points immediately to the left and right side of the camera mounting position. The blanket is then draped over the top of the baby seat. It is draped over the front of the seat to give the appearance of being thrown over the seat, but it camouflages the lens in the process.

Operation

Since the surveillance equipment is built into a standard forty-pound plus size child's safety car seat, the seat may be placed in the front or rear passenger seat of any motor vehicle. The operator must merely be available for the initial placement of the equipment, to adjust the camera and to initiate recording. The operator should strap the seat into a vehicle in a “normal” fashion. The seat will then be facing the potential target area. The seat may be used as forward or rear facing. The operator would place the 12 volt cigarette plug into an appropriate power outlet within the vehicle in order to support all the systems of the unit. The operator would place a standard VHS video cassette cartridge into the VCR. The operator would choose to record the audio sounds inside the car (which would record a standard police radio at the level played inside the car or truck) or to record direct from a line level audio sources by way of the audio jack on the side of the CAR Seat. The switch, which is clearly marked, would then be placed into the appropriate position. The operator would use the LCD screen to locate the target of the investigation, to zoom in as necessary, and to focus the picture. Once all these actions are taken, the operator may use the remote control, or the “Record” button on the face of the VCR to initiate recording of the desired event. The operator may then concentrate on the operation at hand without continued attention to the recording equipment.

Advantages

From the description and drawings a number of advantages of the CAR Seat become apparent:

a) The CAR Seat is buckled into any vehicle, and may be placed in various seats and faced in any direction which may be advantageous to the user.

b) The CAR Seat looks like a regular child safety seat in appearance, therefore not arousing suspicion of the part of the subject or the public.

c) The CAR Seat has the capacity to be moved from vehicle to vehicle therefore reducing cost for maintenance of expensive specialized vehicles.

d) The CAR Seat is easy to handle and weighs 25 pounds.

e) The CAR Seat may be operated at all times by the driver of the vehicle or it may be left unattended for periods of time.

f) The CAR Seat utilizes standard surveillance components and will require minimal specialized skills or training.

g) The CAR Seat may be completed with low light cameras as fits the users particular needs.

h) The CAR Seat provides high quality audio recordings with the capacity to input various devices to the VCR audio input.

i) The CAR Seat is strapped into a vehicle therefore it is able to operate while standing still or moving at high or moderate rates of speed

j) The CAR Seat is designed to be used in moderately close surveillance situations (but not necessarily in extreme close situations) and is therefore the most versatile, easy to use tool available for covert video and audio recordings of outside, non-site-specific events.

Conclusions, Ramifications, and Scope

It then becomes readily apparent, upon examination of the potential of this tool, how useful it would be to any type of investigator who must provide objective proof of specific events in a covert or clandestine environment. The investigator may determine that video recording should be done with a very limited preparation time, may set up his surveillance equipment, conduct the recording, and secure his evidentiary tape without leaving the confines of an ordinary sedan or truck. No special vehicle is needed with a dedicated operator who must travel a long distance to prepare for the recording. No cumbersome video camera is held for long periods, in the open by an investigator with other obligations while the event is taking place. And no information is lost because the operator had to get out of the car to use the bathroom or make a phone call.

Although the description above contains many specifications, these should not be construed as limiting the scope of the invention but merely as providing illustrations of some of the presently preferred embodiments of this invention. For example, many types of cameras, various recorders, and other sized TFT LCD monitors may be used to provide a customized version of the Complete Automobile Recording Seat.

Thus the scope of the invention should be determined by the appended claims and their legal equivalents, rather than by the examples given.

I claim:

1. A child's automobile safety seat having installed within it complete audio and video surveillance system with monitor usable for the purpose of collecting evidence or documenting events in a covert manner while still being easily moved from automobile to automobile for rapid deployment of the system:

2. The Child's safety seat described in claim 1 is fitted with a VHS video cassette recorder which is placed in such a way as to be concealed from casual observation and still be accessible to the user of the device.

3. The child's safety seat described in claim 1 is cut to allow a high quality video camera to be concealed in the top area to provide a video signal to the video cassette recorder described in claim 2.

4. The camera described in claim 3 is fitted with a manually operated zoom lens that can be adjusted by the operator as needed for the specific circumstances.

5. The child's safety seat described in claim 1 is fitted with a microphone for the purpose of recording all sounds in the area.

6. The child's safety seat described in claim 1 is fitted with a switch to control the use of the installed microphone described in claim 3.

7. The child's safety seat described in claim 1 is fitted with a connector that is routed to the audio input of the video cassette recorder for the purpose of recording sounds from selected sources.

8. The child's safety seat described in claim 1 is fitted with a monitor for the purpose of allowing the operator to see what is being recorded by the video cassette recorder.

9. The child's safety seat described in claim 1 is fitted with a cord that will allow the systems of the seat to be powered by a 12-volt power source.

10. The child's safety seat is fitted with the various parts in such a way as to hide its true purpose and to allow for clandestine usage of the devices installed upon the car seat.

11. The car safety seat described in claim 1 is partially covered with an ordinary blanket to disguise the true purpose of the items fitted onto the car seat.
